(19) United States
(12) Patent Application Publication
(10) Pub. No.: US 2026/0273796 A1
(43) Pub. Date: Sep. 17, 2026

(54) METHOD FOR MANUFACTURING A COLOR-FAST AND WEATHER-RESISTANT BOARD

(71) Applicant: SWISS KRONO Tec AG, Luzern (CH)

(72) Inventors: Joachim Hasch, Berlin (DE); Roger Braun, WILLISAU LU (CH); Norbert Kalwa, Horn – Bad Meinberg (DE); Dorin Moisch, Luzern (CH)

(73) Assignee: SWISS KRONO Tec AG, Luzern (CH)

(21) Appl. No.: 19/168,612

(22) PCT Filed: Mar. 18, 2024
(86) PCT No.: PCT/EP2024/057145

§ 371 Date: Sep. 24, 2025

(30) Foreign Application Priority Data
Mar. 28, 2023 (EP) 23164650.6

(51) Int. Cl. B27N 7/00; B27N 3/04; B27N 3/06; B27N 3/08; C08K 3/36; C09D 5/00; C09D 7/61; C09D 135/02

(52) U.S. Cl. CPC B27N 7/005; B27N 3/04; B27N 3/06; B27N 3/08; C08K 3/36; C09D 5/002; C09D 7/61; C09D 135/02; C08K 2201/011

(57) ABSTRACT

The invention relates to a method for manufacturing a color-fast and weather-resistant board. In order to provide a color-fast and weather-resistant board with a simple coating, it is provided that a waterproof carrier board is provided to which a first layer of a coating selected from the group comprising decorative paper, finish foil, veneer, lacquer, continuous pressure laminate (CPL) or high pressure laminate (HPL) is applied and to which a second layer of a coating is applied which is a lacquer layer, a layer of oil, wax or glaze. The invention further includes a color-fast and weather-resistant board.

### BACKGROUND OF THE INVENTION

The invention relates to a method for manufacturing a color-fast and weather-resistant board.

Weather-resistant boards for outdoor applications are known, for example from WO 2020/211 989A1 . The board disclosed there is provided with complex, multi-layered coatings that allow it to be used for outdoor applications.

### SUMMARY OF THE INVENTION

It is the object of the invention to propose a method for manufacturing a board with a simpler coating that is weather-resistant and also as color-fast as possible.

This object is solved by a method for manufacturing a color-fast and weather-resistant board and by a color-fast and weather-resistant board as disclosed herein.

The method according to the invention for manufacturing a color-fast and weather-resistant board provides a waterproof carrier board to which a maximum three-layer coating is applied directly or with a fixing agent.

A waterproof carrier board is known, for example, from WO 2020/211 988 A1 or WO 2020/211 989A1 . Alternatively, a waterproof carrier board is used, which is manufactured as follows:
providing fibers,
providing the binder,
providing an elasticizing additive
applying the binder and the elasticizing additive,
forming the fiberboard cake from the fibers provided with binder and elasticizing agent,
pressing the fiberboard cake in a press with curing of the binder to generate a carrier board, wherein 15 wt.-% to 35 wt.-% melamine resin or phenolic resin and 5 wt.-% to 20 wt.-% urea resin as well as 0.1 wt.-% to 7 wt.-% of the elasticizing additive, in each case based on the total weight of the carrier board (atro), are used as binder.

To manufacture the waterproof carrier board, fibers are first provided. Organic or inorganic fibers can be used. Natural fibers, e.g. lignocellulosic fibers, cotton or linen fibers or synthetic fibers such as fibers made of thermoplastic material such as polyethylene or polypropylene, but also polycarbonate, polyacrylate, polymethacrylate or polyurethane can be used for manufacturing the waterproof carrier board. Inorganic fibers such as carbon fibers or fibers made of mineral or ceramic raw material or glass fibers are suitable for manufacturing the waterproof carrier board, particularly when mixed with other fibers. In particular, mixtures of fibers, especially mixtures of the aforementioned fibers, can be used for manufacturing the waterproof material. Mixtures of fibers make it possible to adjust the properties of the waterproof material, e.g. the elasticity or the bending properties, the dimensional stability, the strength, but also the manufacturing properties or the processability. Fibers in the sense of the present invention are also fiber bundles; also included are smaller chip materials, insofar as their fibers can still be largely coated with binder. According to the invention, it is preferred if the fiber content of the carrier board is less than 50% by weight of the total weight of the carrier board. It is further preferred if the proportion of lignocellulosic fibers is less than 45% by weight of the total fiber content.

Binders are provided for manufacturing the waterproof carrier board. Melamine or phenolic resin on the one hand and urea resin on the other are used. The binder used preferably contains melamine resin, typically melamine-formaldehyde resin. Phenolic resin can be used as an alternative to melamine resin or in a mixture with melamine resin. Although phenolic resin is waterproof, it is dark in color, and, due to its alkali content, hygroscopic to a small extent. However, the inventors have recognized that, despite its hygroscopic properties, phenolic resin can be used for manufacturing a waterproof board. The individual resins mentioned above, in particular melamine resin, urea resin and phenolic resin, can be used both in a mixture with each other and as mixed condensates. Particularly suitable resins are, for example, guanamine resin, melamine-formaldehyde resin, melamine-urea-formaldehyde resin (MUF resin), but also melamine-urea-phenol-formaldehyde resin (MUPF). A guanamine resin is disclosed, for example, in EP 0 011 049A1 . According to the invention, melamine resin and/or phenolic resin are used in combination with urea resin. According to the invention, the proportion of melamine resin in the binder is 15 wt. % to 35 wt. % based on the total weight of the carrier board (atro), in particular 20 wt. % to 30 wt. %, advantageously 20 wt. % to 25 wt. %, particularly preferably 15 wt. % to 25 wt. %. The melamine resin can be replaced in whole or in part by phenolic resin. The proportion of urea resin according to the invention is 5 wt. % to 20 wt. %, advantageously 5 to 18 wt. %, preferably 10 wt. % to 18 wt. %, particularly preferably 10 wt. % to 15 wt. %, in each case based on the total weight of the carrier board (atro). The total amount of binder used for manufacturing the waterproof carrier board is preferably up to 48% by weight, particularly preferably from up to 45% by weight, advantageously up to 43% by weight, particularly advantageously from 25% by weight to 40% by weight, in each case based on the total weight of the carrier board (atro). Advantageously, melamine resin or phenolic resin on the one hand and urea resin on the other hand are used in a ratio of 3.5:1 to 1:1, advantageously between 3:1 and 1:1, in particular of 2.5:1, preferably of 2.5-1.5:1. Within the above-mentioned limits, the ratio between melamine resin or phenolic resin on the one hand and urea resin on the other can be continuously adjusted.

Advantageously, thermoplastic binders are avoided or excluded, in particular the use of thermoplastic binders of more than 7% by weight is avoided or excluded. The carrier board according to the invention is preferably free of halogens (e.g. fluorine, chlorine), but also of terephthalates.

According to an advantageous embodiment, the elastic properties of the waterproof carrier board can be modified, in particular improved, by the addition of an elastomer or thermoplastic which is used as an elasticizing additive, e.g. by adding polyvinyl acetate (PVAc) or ethyl vinyl acetate (EVA), but also a modified isocyanate compound. Acrylate or styrene acrylate are preferably used for elasticizing the waterproof carrier board, especially in the form of a liquid additive such as a dispersion or emulsion, because they are waterproof. However, glycol, e.g. mono- or diethylene glycol, is also suitable for elasticizing the waterproof carrier board, as are caprolactam, longer-chain diols or triols, e.g. glycerin, and polyols, sugars, sugar alcohols or guanamine compounds are also suitable as elasticizing additives. The above-mentioned elasticizing additives can be used on their own, but also in a mixture of two or more of the above-mentioned components. The addition of elastomers or thermoplastics reduces the brittleness of the waterproof carrier board and improves its elastic properties, e.g. the modulus of elasticity. The addition of elasticizing additives also improves the flatness of the waterproof carrier board. The elasticizing additive is used as a solid calculated in proportion to the total amount of the waterproof carrier board (atro) in an amount of 0.1% by weight to 7% by weight, preferably from 1% by weight to 5% by weight, advantageously 2% by weight to 4% by weight.

According to an advantageous embodiment of the invention, up to 1% by weight of a hardener is added to the binder, which accelerates the hardening of the binder, usually a chemical reaction such as a condensation reaction or an addition reaction. A typical example of a hardener is ammonium sulphate.

Further advantageous is the use of a hydrophobizing agent for manufacturing the waterproof carrier board according to the invention. For example, paraffin or wax can be used, which, usually as an emulsion, are typically used in amounts of up to 4% by weight based on the weight of the board-shaped material.

Optionally, the waterproof carrier board contains aggregates. As a possible aggregate, fillers can help to optimize the weight of the board-shaped material, usually to minimize it, but in individual cases also to increase it, or they can help to further improve the matrix structure of binder and fibers. An aggregate or a combination of aggregates can alternatively or additionally serve to optimize certain properties of the boards, e.g. electrical or thermal conductivity, insulating properties or strength properties. An aggregate usually replaces fibers in the waterproof carrier board. Since the waterproof carrier board should have minimal swelling in the presence of water, in particular minimized thickness swelling, non-hygroscopic or non-swelling aggregates or fillers as well as aggregates or fillers that are resistant to hydrolysis are preferred. Such aggregates or fillers can be mineral particles, but also ceramic, synthetic or particles made of glass or metal. For example, calcium carbonate (CaCO3) and/or baryte (BaSO4) can be used as fillers, particles of metal can be used to improve thermal and/or electrical conductivity or expanded plastic particles can be used to reduce the weight. The size of the particles is preferably not larger than one millimeter, preferably between 10 μm and 800 μm. The particles can have any shape, e.g. granular or powdery, but also thread-like. Mixtures of different particles can also be used, e.g. mixtures of different materials, shapes or sizes. Up to 30% by weight of aggregate based on the total weight of the waterproof carrier board (atro) is used, particularly preferably up to 20% by weight, advantageously up to 15% by weight. The lower limit of the amount used results from the detectability of an aggregate or filler. The aggregate or filler can be applied to the fibers before or after applying the binder, preferably by spraying or scattering.

Preferably, hot presses are used for manufacturing the waterproof carrier board, the press plates or circumferential metal belts of which are heated to a predetermined temperature. Suitable press temperatures can be selected from 110° C. to 250° C., preferably from 110° C. to 180° C., preferably from 140° C. to 160° C. (temperature of the press plate or press belt). The thinner the board, the lower the pressing temperature can be selected. Alternatively, the pressing speed can be increased, i.e. the pressing time can be shortened. Suitable pressing pressures are for example in a range from 0.3 N/mm² to 5.5 N/mm², in particular 1 N/mm² to 3 N/mm². The pressing time is advantageously 6 seconds/mm panel thickness (hereinafter: s/mm) to 60 s/mm, usually 10 s/mm to 30 s/mm, preferably 20 s/mm to 25 s/mm. In order to minimize the pressing time, the temperature can be increased within the aforementioned range. In continuous presses, the feed rate of the circulating metal belts between which the waterproof carrier board is manufactured by pressing is usually between 250 mm/second and 400 mm/second, preferably between 300 mm/second and 350 mm/second, depending on the length of the press.

A waterproof board, the surface of which may be applied with a coat of paint, oil or wax or a glaze, can be used in outdoor applications, but is generally not weather-resistant and color-fast in accordance with DIN EN 4892-2 11/2021, method A or ISO 105A02 , A03, A04 and A05 and therefore usually does not meet the requirements of tenders.

According to the invention, a coating is applied to this waterproof carrier board, which has, for example, fibers and up to 35% by weight melamine resin or phenolic resin and up to 20% by weight urea resin, in each case based on the total weight of the carrier board (atro) as a binder, which has a first layer selected from the group comprising decorative paper, finish foil, lacquer, continuous pressure laminate (CPL) or high pressure laminate (HPL) and a second layer, which is a lacquer layer. The lacquer layer can be applied in several layers, e.g. to achieve a greater thickness of the lacquer layer. When applying a lacquer layer in several layers, it can either be applied wet-on-wet, with the individual layers being applied immediately one after the other. Alternatively, the previously applied lacquer layer can be gelled, i.e. it can be at least partially cured using UV light or electron beam curing, for example.

The coating, in particular its first layer, can advantageously be applied directly or with the aid of a fixing agent to the waterproof carrier board. Typical examples of direct application include pressing a coating containing a synthetic resin, e.g. a paper or veneer impregnated with melamine resin, phenolic resin or another synthetic resin, in particular a resin impregnated decorative paper, with a surface of the carrier board. A coating that is fixed to the surface of the carrier board with a fixing agent, e.g. a first layer of veneer, CPL or HPL or film, is often fixed with an adhesive, in particular a melt adhesive, in particular a hot melt adhesive.

Boards, in particular wood-based boards for outdoor applications, previously had to be as waterproof as possible in order to largely rule out dimensional changes during their service life. The board produced according to the invention must also be color-stable and weather-resistant. Color-fastness is particularly important for outdoor applications because the board is usually exposed to the weather for years, e.g. as a facade panel or as an exterior window sill, for outdoor constructions, e.g. for fences, pergolas or stables, or when used for outdoor furniture, e.g. as a table top for outdoor tables. Even if the board itself is weather-resistant, the decor must also remain color-stable in the long term in order to ensure that the aesthetic appearance of the board remains as consistent as possible. In order to test the weather-resistance and color-fastness of the board, the weathering behavior of the coated board is tested in a test device in accordance with DIN EN ISO 4892-2 11/2021, using method A for 3000 hours. The color-fastness is tested in connection with the present invention in accordance with ISO 105A02 , A03, A04 and A05. In particular, in the color-fastness test according to ISO 105, a gray scale for evaluating the bleeding of the color (A02) or a gray scale for changing the color (A03) is tested.

The application of the coating, in particular the second layer of the coating, a primer but also a fixing agent can be carried out by pressing, rolling, doctoring, spraying and/or casting, whereby pressing is preferably suitable for resin impregnated paper or film, in particular for lacquer-coated paper or lacquer-coated finish foil. Oil, wax or a glaze can be applied by rolling, doctoring, spraying and/or casting.

In order to better fix the first or second layer of lacquer to the substrate, a primer is preferably applied that adheres well to the substrate, in this case the surface of the carrier board, the decorative paper, the finish foil, the continuous pressure laminate (CPL) or the high pressure laminate (HPL), and also forms a good bond with the lacquer of the first or, in particular, the second layer of lacquer. Acrylic compounds, which are preferably UV curing, are used as primers, for example. The primer is advantageously applied to the respective substrate in an amount of up to 25 g/m² and at least partially cured. The primer is usually applied in liquid form. The primer helps to ensure that the first or second layer of the coating adheres well. This is promoted by the fact that the primer and lacquer are preferably applied wet-on-wet; in other words, it is not dried after the primer has been applied.

A particularly simple coating of a carrier board that is effective in terms of color-fastness involves applying a primer to the surface of the carrier board, which improves the adhesion of lacquer to the surface of the carrier board. The primer preferably has no influence on the color-fast and weather-resistant properties of the board according to the invention. A first layer of a lacquer and a second layer of a lacquer, in particular a UV curing or electron beam curing lacquer (an ESH lacquer), can then be applied to the primer. Preferably, a total of up to 150 g/m² of lacquer is applied to the surface of the carrier board. The first layer and the second layer may have the same or different lacquers or lacquer compositions. The curing of the lacquer, i.e. the polymerization of the lacquer molecules, as well as the curing of the primer is preferably carried out at least partially after the application of the primer or each layer of lacquer. Particularly preferably, complete curing is carried out after the application of each layer.

The application of two layers of lacquer in particular enables economical coating of the waterproof board, which nevertheless opens up many variants in terms of visual and technical design, as pigments and additives, which play a key role in determining the lacquer properties, can be used optimally. For example, a colored lower coating layer can be covered by an upper coating layer mixed with metal particles in order to generate special aesthetic effects or a lower coating layer mixed with anti-fungicides can be covered by an upper coating layer mixed with conductive particles in order to meet technical requirements such as color-fastness and/or weather-resistance, abrasion resistance, conductivity.

According to an alternative embodiment of the method according to the invention, a resin-impregnated paper, in particular a decorative paper, is applied to the carrier board, wherein the resin-impregnated decorative paper is optionally provided with a primer as the first layer of the coating and, according to the invention, with a second layer of lacquer. The paper, for example with a paper weight of 15 g/m² to 250 g/m², can be a neutral paper or a paper with a decor. It is impregnated with a synthetic resin, usually a melamine resin, so that a paper weight of 150 g/m² to 400 g/m² is typically achieved for the paper impregnated with synthetic resin. After impregnation, which is usually carried out in an impregnation bath, excess synthetic resin is wiped off and the paper impregnated with the specified amount of synthetic resin is dried so that the synthetic resin no longer sticks but is still reactive, i.e. the synthetic resin has not yet configured the complete polymer skeleton. The synthetic resin can partially penetrate the paper. However, it can also protrude on one or both sides of the paper if an excess of synthetic resin is applied to the paper. A layer of primer is optionally applied to the dried, resin impregnated paper. The primer is used to optimally bond the subsequent coating layer to the resin-impregnated paper. After application, the primer is advantageously at least partially dried. This coating is known and proven for indoor applications; however, it is surprising that it is also sufficiently color-fast and weather-resistant for outdoor applications.

A layer of lacquer is preferably applied to the resin impregnated paper coated with a primer, in particular a UV curing or electron beam curing lacquer. Advantageously, a maximum of 50 g/m² lacquer is applied.

The resin-impregnated paper is placed on the carrier board, with the side provided with the lacquer layer facing away from the carrier board, and the resin-impregnated paper is then pressed directly with the carrier board.

The individual synthetic resin layers are advantageously dried, e.g. by means of hot air or IR radiation, to a moisture content of 5% to 25%, preferably 4% to 10%. They then reach the so-called B-state, in which the synthetic resins are usually no longer tacky but still reactive. The fully applied synthetic resin coating is then cured in a press, e.g. a short-cycle press, under the effect of pressure and elevated temperature. Typical pressing conditions include a temperature of from 160° C. to 220° C., preferably from 180° C. to 200° C., a pressing pressure of from 20 kg/cm² to 50 kg/cm², preferably from 22 kg/cm² to 40 kg/cm² and a pressing time of from 5 seconds to 60 seconds, preferably from 5 seconds to 30 seconds.

This embodiment of the invention is easy to manufacture in existing installations and is particularly resistant to the effects of weathering. The color, which is introduced, for example, by a decorative paper or the lacquer, remains stable even if the board is exposed to the weather.

Another embodiment of the invention provides that instead of the resin impregnated paper, a finish foil is used, which is coated with a layer of a primer and then with a layer of a lacquer before being applied to the carrier board. The application and drying of primer and lacquer is carried out as described above. Unlike the resin impregnated paper, the finish foil is usually applied to the carrier board using a fixing agent. The fixing agent, preferably a melt adhesive or a hotmelt, is applied to the carrier board or the finish foil and the carrier board and finish foil are permanently bonded together under the effect of pressure in a press, e.g. a vacuum press.

Finally, the serviceability of the surface of the workpiece according to the invention can be improved by applying a lamination. The lamination has a coating, usually with a ready-to-use outer surface, which is usually bonded to the material according to the invention, e.g. as described above, by means of a hot melt or by means of another adhesive. A typical embodiment of a lamination is a CPL or HPL consisting, for example, of a plurality of synthetic resin-impregnated papers, whereby the synthetic resin-impregnated papers or films are already pressed with one another while the synthetic resin is fully cured. However, PVC films can also be laminated. The CPL or HPL or other coatings with a ready-to-use surface such as PVC film are typically applied to the surface of the board-shaped workpiece using a hot melt adhesive. Pressing on the lamination is carried out, for example, at 80° C. to 200° C. in a laminating press at a pressure of up to 300N/cm² . The pressing time is short and is usually a maximum of 1 second. Laminating systems are usually configured as calendering systems.

Even if the surface of a lamination is already ready for use in itself, this does not preclude the application of a further coating or sealant, either for aesthetic reasons or to further improve the serviceability. Typically, a lacquer is applied as a second layer, for example, to achieve special visual effects or because at least one layer of lacquer contains corundum to improve abrasion resistance or aerosile to further improve scratch resistance. The second layer can be structured from several layers of lacquer, which are applied one after the other, in the case of lamination, but also on the other first layers of the coating mentioned above. The individual layers of lacquer may each be fully cured before the subsequent layer of lacquer is applied, or they may be uncured or partially cured. The individual layers may be manufactured from the same lacquer or from different lacquers or lacquer compositions.

A veneer can be used as the first coating. It can either be provided with adhesive and laminated in a veneer or laminating press or it can be bonded to the carrier board by pressing in a short-cycle press (KT press). A primer can be used, e.g. to improve the bonding of the adhesive or synthetic resin. The second coating can be, for example, veneer or paper, lacquer, oil, wax or a glaze, each of which is applied in one or more layers, advantageously in an amount of up to 250 g/m², preferably up to 200 g/m², in particular 100 g/m² , at least 25 g/m².

Advantageously, the second layer of the coating can first be applied to the first layer and optionally cured before the bonded first and second layers can then be applied to the carrier board. A coating is therefore applied to the carrier board, in which a decorative paper, a finish foil or a CPL or HPL are each already coated with a layer of lacquer.

Optionally, a structure can be embossed into the second layer of the coating, preferably before or while it is curing. In particular, the structure can imitate natural structures of wood or stone, but it can also imitate traces of use or production marks of wood or stone structures, for example.

The features of the first and second layers explained above can be combined with each other as desired.

In the context of the present invention, all % figures refer to percent by weight (wt %) unless otherwise stated. All quantities, e.g. “g/m²”, in particular for lacquer or primer, refer to 100 % solids, unless otherwise stated. In fact, liquid-applied lacquers or primers in particular are processed at significantly lower solids contents of typically 40 % to 60 % by weight, as specified by the manufacturers. The term “atro” refers to fibers that have been dried at 105° C. to constant weight.

### DETAILED DESCRIPTION

Details of the invention are explained below with reference to exemplary embodiments:

The carrier board is a waterproof board which may be composed, for example, according to the above-mentioned components (fibers, binder or adhesive, elasticizing additive, hardener, hydrophobizing agent and/or filler). For the following exemplary embodiments, a Corepel board is used as a waterproof carrier board, for example, which has the following composition: 30 wt. % melamine resin, 15 wt.-% urea resin, 4 wt.-% diethylene glycol as elasticizing additive, 0.5 wt. % ammonium sulphate as hardener, 15 wt.-% calcium carbonate as filler and 33 wt.-% atro fibers. The Corepel board is pressed at 180° C. pressing temperature and 4 N/mm² pressing pressure for 6 s/mm board thickness, for exemplary embodiments 1 to 3 to form an 8 mm board and for exemplary embodiment 4 to form a 10 mm board. The board is then sanded and coated according to the following exemplary embodiments.

### Exemplary Embodiment 1

A waterproof board, here for example a sanded 8 mm Corepel board (format: 2800×1000 mm), is first coated with a UV primer, e.g. an acrylate primer that can be cured with UV light, at a rate of 1-20 g/m² using a paint roller on a coating line operated at a speed of 30 m/min. It is gelled with a gallium lamp at 80 watts/cm², i.e. at least partially cured. In an alternative embodiment, the primer can be dispensed with. A pigmented ESH lacquer (electron beam hardening lacquer), in this case a urethane acrylate lacquer, is then applied in a quantity of approx. 100 g/m² using a casting machine. The lacquer contained approx. 15 % pigment (white) and is preferably adjusted to a viscosity of 70-80 sec (4 mm DIN cup) with reactive thinner in this exemplary embodiment. Hexanediol diacrylate and trimethylolpropane triacrylate are preferably used as reactive thinner. The lacquer is gelled with an electron emitter (225 V, 100 kGray). All lacquer curing with the aid of electron emitters mentioned in connection with the present invention is preferably carried out under an inert gas atmosphere, e.g. under a nitrogen atmosphere. Alternatively, a UV curing lacquer can be used.

A roller unit is then used to apply a nanoparticle-containing topcoat, for example an acrylate lacquer containing fumed silica. The lacquer is applied in a quantity of approx. 10-20 g/m 2. The entire structure is then cured by means of an electron emitter (225 V, 250 kGray). Alternatively, a UV curing polyurethane lacquer can also be used. After cooling, the coated boards are cut to size in a profiling equipment. A sample from this production is then tested in accordance with DIN EN ISO 4892-2, 11/2021, method A 3000 h. After the test, no color deviations or other defects were visible (gray scale rating: 4-5, ISO 105A2 , A3). The coating described above is therefore ideally suited for use in outdoor areas, e.g. as a facade panel. The waterproof board coated according to the invention also proves to be acid-resistant and scratch-resistant.

### Exemplary Embodiment 2

A decorative paper (80g/m², roll width: 2070) is impregnated in an impregnation channel with approx. 80 g melamine resin/m² (calculated as 100 % by weight solids). The impregnation channel is operated at a speed of 30 m/min. The paper is impregnated with resin in the impregnation trough and preferably the upper face is sharply stripped with a knife doctor blade before the flash dryer. In the drying channel, the impregnate is dried to a residual moisture of 5 wt % to 10 wt %, typically approx. 6 wt % to 8 wt %. After the flash dryer, the paper is first coated with a UV primer in a quantity of 15-20 g/m² using a coating roller. It is gelled with a gallium lamp at 80 watts/cm². An ESH lacquer is then applied to the upper face of the decorative paper using a lacquer roller (lacquer from example 1) . The quantity was 40-50 g/m². The lacquer application can also be carried out in two layers of 20-25 g/m² each, either wet-on-wet or with the first layer being gelled. The complete lacquer application is then cured with an ESH lamp (225 V, 100 kGray). Lacquer curing is carried out under inert gas, e.g. nitrogen. The impregnates are then cut to size (2800×2070 mm). They are then pressed onto both sides of a waterproof board, in this case an 8 mm Corepel board, in a short-cycle press. The pressing parameters were: a pressing temperature of 180° C., a pressure of 40 N/cm² and a pressing time of 20 seconds.

A sample for a weathering test is cut from the large-format board coated in this way and tested in the same way as the sample from example 1. Again, no color changes or other defects are detected (gray scale rating: 4-5, ISO 105 A2 , A3).

### Exemplary Embodiment 3

A decorative paper with a paper weight of 80 g/m² and a width of the roll: of 2070 mm is impregnated in an impregnation channel with approx. 80 g melamine resin/m² (based on 100 % solids by weight). The impregnation channel is operated at a speed of 30 m/min. The paper is impregnated with resin in the impregnation trough and the upper face is scraped off sharply with a knife doctor blade, preferably before the flash dryer. In the drying channel, the impregnate is dried to a residual moisture of approx. 6%.

After the flash dryer, the paper is first coated with a UV curing primer at a rate of 15-20 g/m² using a coating roller. It is gelled with a gallium lamp at 80 watts/cm², but not fully cured. A UV lacquer, preferably an acrylic lacquer, is then applied to the upper face of the decorative paper using a lacquer roller. The quantity was 20-30 g/m². The lacquer structure (primer and lacquer) is then cured with a UV lamp (Hg, 120 watts/cm). The lacquer curing is carried out under inert gas, e.g. nitrogen. The lacquer is advantageously mixed with photoinitiators, which promote color stability.

The impregnates are then cut to size (2800×2070 mm). They are then pressed onto both sides of a waterproof board, e.g. an 8 mm Corepel board, in a short-cycle press. The pressing parameters are identical to the pressing conditions of exemplary embodiment 2.

A sample for a weathering test is cut from a large-format board coated as described above and tested in the same way as the sample from example 1. Again, no color changes or other defects are detected (gray scale rating: 4-5, ISO 105 A2 , A3).

### Exemplary Embodiment 4

A finish foil, i.e. a paper impregnated with synthetic resin, in which the synthetic resin has cured in contrast to the decorative paper, is used to coat a waterproof board, typically the waterproof board described above. The finish foil (width: 1300 mm) has a paper weight of 80 g/m² and is impregnated with 100 g/m² to 120 g/m² synthetic resin. Urea resin or a mixture of urea resin and acrylic resin is usually used here, but another, preferably thermosetting synthetic resin or a mixture of synthetic resins can also be used. The finish foil in a plain decor, here in the color gray, which was impregnated in a first step with a mixture of an acrylate resin and a urea resin, is first coated on the upper face in a coating line using a paint roller with a UV primer in an amount of 15-20 g/m². The coating line is operated at 30 m/min. The primer is gelled with a gallium lamp at 80 watts/cm² . An ESH lacquer is then applied to the upper face of the finish foil using a lacquer roller. The lacquer from exemplary embodiment 1 is used for this. The amount used is 40-50 g/m²; it can be applied in one or more layers, as described in exemplary embodiment 1. The lacquer structure consisting of primer and lacquer is then cured with an ESH emitter (225 V, 100 kGray). Curing using the electron emitter is carried out in an inert gas atmosphere, e.g. nitrogen.

The lacquered finish foil is then laminated onto the upper face of a Corepel board with a thickness of 10 mm using a PU hotmelt (application quantity: 100 g/m² ) in a laminating line. The same lacquered finish foil is laminated onto the backside of the Corepel board. A sample for a weathering test is cut from a large-format board and tested in the same way as the sample from example 1. Here too, no color changes or other defects are detected (gray scale rating: 4-5, ISO 105 A2 , A3).

### Exemplary Embodiment 5

A waterproof board, e.g. as described above, is either painted or coated with a primer according to a first alternative. For example, UV curing primers or lacquers, for example acrylate-based, or electron beam curing primers or lacquers are suitable. A decor is printed onto this first layer of lacquer or the primer, at least in sections. The decor is preferably applied digitally, for example using an inkjet printer. According to a second alternative, a decor is printed at least in sections directly onto the e.g. sanded and dedusted surface of the waterproof board and, if printed with a UV curing ink, this is cured immediately after application of the decor. A second layer of lacquer is applied to the first layer of lacquer provided with a decor at least in sections according to the first or second alternative. For example, 8 g/m² to 150 g/m², typically 15 g/m² of an acrylate lacquer is applied. The lacquer used is preferably a UV or electron beam curing lacquer, typically in an amount of up to 150 g/m². Advantageously, the first layer of lacquer is at least partially dried or cured, typically gelled, before the decor is applied in order to enable the application of a precise decor. After application of the second lacquer layer, which is applied in an amount of 8 g/m², for example, the lacquer layers are cured. The first and or the second layer of lacquer can be applied in one or more layers, either wet-on-wet or after the previously applied layer has been gelled. Optionally, a structure can be embossed into the lacquer, in particular into the second lacquer layer, preferably before or during curing.

A sample for a weathering test is cut from the board provided with two layers of lacquer and tested in the same way as the sample from example 1. Here too, no color changes or other defects are detected (gray scale rating: 4-5, ISO 105 A2 , A3).

### Exemplary Embodiment 6

A paper, veneer or plastic film is laminated onto a waterproof board, e.g. an 8 mm Corepel board. The paper, e.g. a paper with a sheet weight between 60 g/m² and 100 g/m² or the plastic film, e.g. made of polyethylene, is optionally provided with a decor, in particular with a decor applied digitally, e.g. by means of an inkjet printer. The paper, veneer or plastic film is glued or laminated to the waterproof board, e.g. using a hot melt adhesive. Before or after application to the waterproof board, the paper or plastic film is provided with a layer of lacquer, preferably a UV or electron beam curing lacquer, e.g. an acrylic lacquer. The lacquer is advantageously applied in an amount of up to 150 g/m² in one or more layers and cured. Optionally, a structure can be embossed into the lacquer, preferably before or while the lacquer is curing.

The veneer and the paper can alternatively be provided with a layer of oil, wax or a glaze, which is applied in an amount of preferably up to 200 g/m², advantageously up to 150 g/m², in one or more layers.

A sample is cut from each of the boards coated as described above for a weathering test and tested in the same way as the sample from example 1. Again, no color changes or other defects are detected (gray scale rating: 4-5, ISO 105 A2 , A3).

1. Method for manufacturing a board which is color-fast and weather resistant according to DIN EN ISO 4892-2 11/2021 and ISO 105 A2, A3, with a waterproof carrier board having lignocellulosic fibers, with a coating, wherein the coating is applied as a first layer selected from the group consisting of decorative paper, finish foil, lacquer, veneer, continuous pressure laminate (CPL) or high pressure laminate (HPL), and as a second layer, wherein the second layer is a lacquer, a layer of oil, wax or a glaze.

2. The method according to claim 1, wherein the coating is applied by pressing, rolling, doctoring, spraying and/or casting.

3. Method according to claim 1, wherein a primer is applied to the carrier board, the decorative paper, the finish foil, the CPL or the HPL before the lacquer is applied.

4. Method according to claim 1, wherein the second layer is built up from two or more layers of lacquer, oil, wax or glaze.

5. Method according to claim 4, wherein a UV curing or electron beam curing lacquer is selected as the lacquer.

6. Method according to claim 4, wherein a maximum of 150 g/m² of lacquer, oil, wax or glaze is applied.

7. Method according to claim 1, wherein a resin-impregnated paper is applied to the carrier board.

8. Method according to claim 7, wherein the resin-impregnated paper coated with lacquer is applied directly to the carrier board.

9. Method according to claim 7, wherein a maximum of 50 g/m² lacquer, oil, wax or glaze is used for the second layer.

10. Method according to claim 1, wherein a finish foil, a CPL or an HPL, each of which is already coated with a second layer of lacquer, is applied to the carrier board.

11. Method according to claim 10, wherein the finish foil, the CPL or the HPL is each applied to the carrier board with a fixing agent.

12. Method according to claim 10, wherein a melt adhesive or a hot melt adhesive is used as fixing agent.

13. A board which is color-fast and weather resistant according to DIN EN ISO 4892-2 11/2021 and ISO 105 A2 , A3 having a waterproof carrier board to which a coating is applied, the coating comprising a first layer selected from the group consisting of decorative paper, finish foil, veneer, lacquer, continuous pressure laminate (CPL) or high pressure laminate (HPL), and a second layer, the second layer being a layer of lacquer, a layer of oil, wax or a glaze.

14. The board according to claim 13, wherein a primer is applied to the carrier board, the decorative paper, the finish foil, the lacquer, the veneer, the continuous pressure laminate (CPL) or the high pressure laminate (HPL).

15. Board according to claim 13, wherein the carrier board and the finish foil, veneer, continuous pressure laminate (CPL) or high pressure laminate (HPL) are joined together by a fixing agent.

16. Method according to claim 7, wherein the resin-impregnated paper is a resin-impregnated decorative paper.

17. Method according to claim 8, wherein the resin-impregnated paper coated with lacquer is pressed with the carrier board.
